(19) United States
(12) Patent Application Publication
(10) Pub. No.: US 2025/0392073 A1
(43) Pub. Date: Dec. 25, 2025

(54) ELECTRICAL CONNECTOR WITH REDUCED SIGNAL LOSS

(71) Applicant: SINBON ELECTRONICS COMPANY LTD., New Taipei City (TW)

(72) Inventor: Chen-Yu LI, New Taipei City (TW)

(21) Appl. No.: 18/752,103

(22) Filed: Jun. 24, 2024

(51) Int. Cl. H01R 13/518; H01R 13/502; H01R 13/512

(52) U.S. Cl. CPC H01R 13/518; H01R 13/512; H01R 13/5025

(57) ABSTRACT

An electrical connector with reduced signal loss includes a cable module in a housing. The cable module has an engagement assembly which has multiple cable terminals, the engagement assembly is located in the installation slot of the housing, and the engagement assembly has multiple engagement holes to correspondingly clamp and fix the multiple cable terminals. Each cable terminal has a terminal head and a coaxial cable respectively, the terminal head has mating and wire ends, the mating end has an engaging slot, and the engaging slot is disposed in and through the engaging hole of the engagement assembly, and the wire end is connected to the coaxial cable; when the electrical connector is utilized in the connecting male and female connectors, the coaxial cables of the two ends are directly connected through their respective terminal heads, which can effectively reduce signal loss due to connection interface structure reduction.

### BACKGROUND OF THE INVENTION

### 1. Field of the Invention

The present invention relates to an electrical connector, in particular to an electrical connector with reduced signal loss.

### 2. Description of the Related Art

For high-frequency (such as RF) or even high-frequency and high-signal-strength wired signal transmission, a coaxial cable is a generally accepted means of wired signal transmission; in order to meet the needs of a system, multiple coaxial cable segments may have to be connected serially. At this time, two ends of a coaxial cable segment are each connected through a connection to an adjacent coaxial cable segment. In general, the connection on one end connects with an adjacent coaxial cable through a male or a female connector which is convenient for disassembly, that is, the connection is provided with a male connector or female connector on one end, and a female connector or male connector on the other end of the connection. Similarly, the connection on the other end connects with another adjacent coaxial cable through a female or a male connector, and said connection is provided with a male connector or female connector on one end, and a female connector or male connector on the other end of the connection, and thereby the two connections will realize the connections of the two ends of the coaxial cable segment through a pair of male and female connectors on each of the two ends.

However, the above connection method increases the impedance of serially connected multiple coaxial cable segments due to the fact that a pair of male and female connectors is required for each connection between two adjacent coaxial cable segments, which causes significant signal degradation. Therefore, how to minimize the signal loss without affecting the user-end interconnection structure is an ongoing concern in this field.

### SUMMARY OF THE INVENTION

Based on the above, a main purpose of the present invention is to provide an electrical connector with reduced signal loss, which allows the coaxial cable to be directly connected to a terminal head for mating, and the coaxial cable is directly fixed to the connector through the terminal head. When a connector is connected to another connector, the corresponding terminal heads of the two connectors are directly connected. This eliminates the need for a connection interface structure between the connector and the coaxial cable, thus significantly reducing overall impedance and signal loss.

To achieve the aforementioned purpose, the aforementioned electrical connector with reduced signal loss is provided to include a connector, and the connector comprises:

a housing, being hollow and having a front mounting plate and a rear mounting plate inside the housing, an installation slot formed between the front mounting plate and the rear mounting plate, and a plurality of through holes formed respectively on the front mounting plate and the rear mounting plate, and the through holes on the front mounting plate each respectively corresponding to the through holes on the rear mounting plate;

a cable module provided with a plurality of cable terminals detachably installed on a fixed engagement assembly; wherein

the fixed engagement assembly is shape-matched and detachably installed in the installation slot, and the fixed engagement assembly has a plurality of engagement holes; each cable terminal has a terminal head and a coaxial cable respectively, each terminal head has a mating end and a wire end respectively and the mating end is disposed in and through one of the plurality of engagement holes of the fixed engagement assembly, one of the plurality of through holes of the front mounting plate, and one of the plurality of through holes of the rear mounting plate; and the wire end is connected to the coaxial cable.

Preferably, the fixed engagement assembly comprises a fixed engagement piece and a shifting engagement piece corresponding to each other, a plurality of fixed engagement holes formed on the fixed engagement piece, a plurality of extended holes formed on the shifting engagement piece, each of the fixed engagement holes corresponding to a respective one of the extended holes, and each engagement hole being formed by one fixed engagement hole and one corresponding extended hole respectively;

each terminal head of the cable terminals disposed in and through a respective one of the engagement holes, one terminal head of each cable terminal passed through a respective one of the through holes on the front mounting plate, and one coaxial cable of each cable terminal being passed through a respective one of the through holes on the rear mounting plate.

Preferably, more than one wedge is formed on an inner side of the housing, and the front mounting plate and the rear mounting plate are fixed with the more than one wedge.

Preferably, a male slot hole is provided on a top portion of the housing and between the front mounting plate and the rear mounting plate to connect the installation slot to outside of the housing; the cable module is installed in the installation slot through the male slot hole.

Preferably, the housing is provided with at least one screw hole, a screw is driven into the installation slot through the at least one screw hole and exerts thrust on the shifting engagement piece.

Preferably, the fixed engagement piece has a spring side-edge with at least one leaf spring thereon, and a forced edge of the shifting engagement piece is in contact with the at least one leaf spring to bear an elastic force therefrom.

Preferably, when a shifting edge of the shifting engagement piece is pushed to an inserting position, the terminal head of each cable terminal is passed through the respective engagement hole, where the shifting edge and the spring side-edge are opposite sides of the shifting engagement piece.

Preferably, when the shifting edge of the shifting engagement piece is pushed to an engaging position, the terminal head of each cable terminal is clamped and fixed in the respective engagement hole by the corresponding fixed engagement hole and the extended hole.

As can be seen from the above, the way of connecting a connector to a coaxial cable of the present invention is to directly connect the coaxial cable to a terminal head, and directly fixes the terminal head on the connector, and when the coaxial cable is to be connected to another coaxial cable through another connector, the terminal heads on the two connectors are directly connected, thereby eliminating extra interface connection structure between the coaxial cable and the connector, so as to effectively reduce impedance and signal loss.

In order to make the above objects, features and advantages of the present invention more apparent and easier to understand, the following embodiments, together with the accompanying drawings, are described in detail as follows.

### BRIEF DESCRIPTION OF THE DRAWINGS

FIG. 1 is an exploded view of the present invention;

FIG. 2 is an exploded view of a female connector according to a preferred embodiment of the present invention;

FIG. 3 is a cross-sectional view of a female connector according to a preferred embodiment of the present invention;

FIG. 4 is a partially enlarged three-dimensional cross-sectional view of a preferred embodiment of the present invention;

FIG. 5 is a schematic diagram of a penetration of a preferred embodiment of the present invention;

FIG. 6 is a schematic diagram of the engagement of a preferred embodiment of the present invention;

FIG. 7 shows the connection surface of the female connector according to a preferred embodiment of the present invention;

FIG. 8 is a rear view of the female connector according to a preferred embodiment of the present invention;

FIGS. 9-10 are two exploded views of the male connector from different perspectives according to a preferred embodiment of the present invention;

FIG. 11 is a cross-sectional view of a male connector according to a preferred embodiment of the present invention;

FIG. 12 is a view of the connection surface of the male connector according to a preferred embodiment of the present invention;

FIG. 13 is a rear view of the male connector according to a preferred embodiment of the present invention; and

FIG. 14 is an assembled appearance view of a preferred embodiment of the present invention.

### DETAILED DESCRIPTION OF THE INVENTION

The technical solution of the present invention is further described below in conjunction with the accompanying drawings and by means of specific embodiments. In the description of the present invention, it is to be understood that the terms "center", "longitudinal", "lateral", "length ", "width", "thickness", "top", "bottom", "left", "right", "vertical", "horizontal", "top ", "bottom", "inner", "outer", "axial", "radial", "circumferential" and the like indicate orientation or positional relationships based on those shown in the accompanying drawings, and are intended only to facilitate the description of the present invention and to simplify the description, and are not intended to indicate or imply that the device or element referred to must have a particular orientation, or be constructed and operated in a particular orientation and therefore cannot be construed as limitations of the present invention.

Furthermore, the terms "first" and "second" are used for descriptive purposes only and are not to be understood as indicating or implying relative importance or implicitly specifying the number of technical features indicated. Thus, the feature defined with "first", "second" may include one or more such features, either explicitly or implicitly. In the description of the present invention, unless otherwise specified, "more than one" means two or more.

In the description of the present invention, it is to be noted that, unless otherwise expressly specified and limited, the terms "mounted", "connected", and "connecting" are to be understood in a broad sense. For example, it may be a fixed connection, a removable connection, or a connection in one piece; it may be a direct connection, an indirect connection through an intermediate medium, or a connection within two elements. For a person of ordinary skill in the art, the specific meaning of the above terms in the present invention may be understood in a specific context.

The present invention is an electrical connector with reduced signal loss. It mainly provides a cable module in a connector housing. The cable module has its own engagement assembly, and a plurality of cable terminals are provided on the engagement assembly. The engagement assembly is installed in an installation slot of the housing. The engagement assembly has a plurality of engagement holes to correspondingly engage the plurality of cable terminals. Each cable terminal has a terminal head and a coaxial cable respectively. The terminal head has a mating end and a wire end. The mating end has an engaging slot. The engaging slot is engaged and fixed in the engagement hole of the engagement assembly. The wire end is directly connected to the coaxial cable.

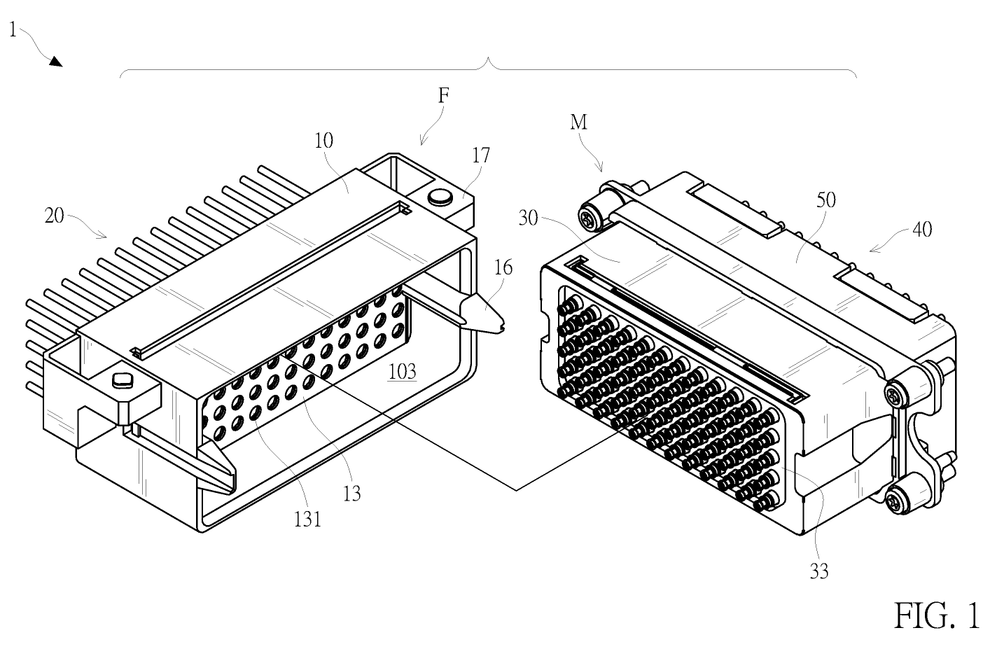

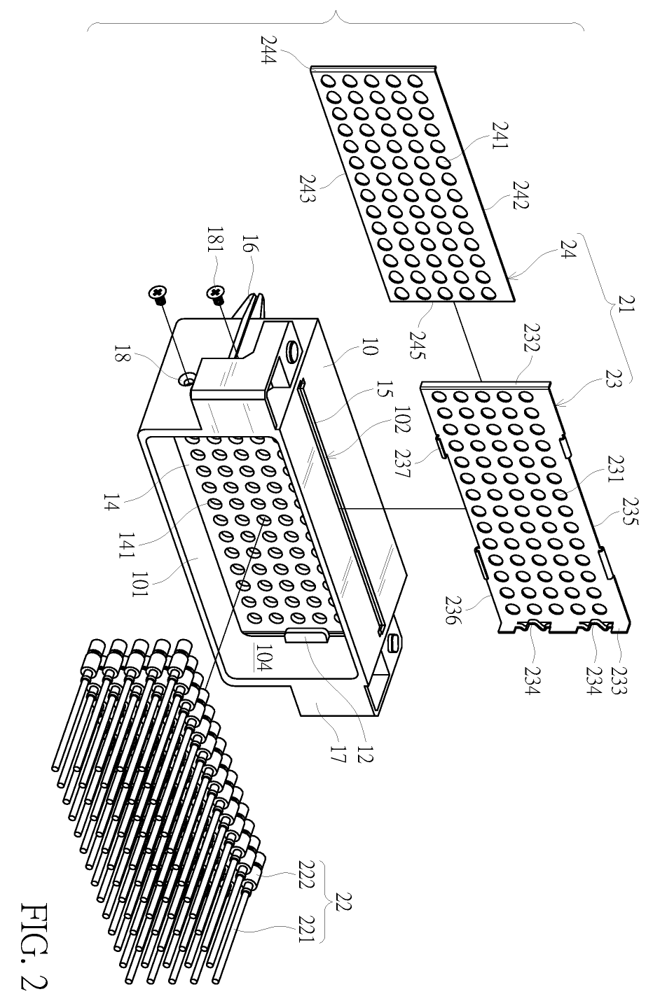

Regarding a preferred embodiment of the present invention, this embodiment is applied to a male connector and a female connector. Please refer to FIG. 1 where an electrical connector with reduced signal loss 1 is shown. The electrical connector with reduced signal loss 1 has a male connector M and a female connector F that can be correspondingly connected. For preferred embodiments of the female connector F, please refer to FIGS. 1 and 2. The female connector F includes a female housing 10 and a female cable module 20; wherein, in this embodiment, the female housing 10 is mainly an end-to-end hollow rectangular frame comprising a top portion, a bottom portion and two side portions, and the hollow rectangular frame has an inner frame-surface 101, where inner surfaces of the top portion, the bottom portion and the two side portions are part of the inner frame-surface 101. The two side portions’ inner surfaces each have a respective elongated wedge 12 formed thereon. A front female mounting plate 13 and a rear female mounting plate 14 are provided inside the female housing 10. Both lateral sides of the front female mounting plate 13 and the rear female mounting plate 14 are respectively fixed with the wedges 12. A female slot hole 15 is formed on top of the female housing 10. And the front female mounting plate 13, the rear female mounting plate 14, and the female slot hole 15 together form a space of a female installation slot 102. The front female mounting plate 13 and the inner frame-surface 101 form a space of a mating slot 103. The rear female mounting plate 14 and the inner frame-surface 101 form a space of a female cable slot 104. The female installation slot 102 and the female cable slot 104 are used to install the female cable module 20, and the mating slot 104 is used to connect with the male connector M.

In this embodiment, in order to further facilitate the docking of the female connector F and the male connector M, the elongated wedges 12 on the two side portions’ inner surfaces are respectively extended beyond the inner frame-surface 101 along a docking direction to form protrusions 16, and ends of the protrusions 16 are gradually tapered. The outer surfaces of the two side portions of the female housing 10 each have a respective fixing base 17 formed thereon. The fixing base 17 is equipped with fixing holes, which can be used to fix the female housing 10 to a circuit board or other carrier.

Please refer to FIG. 2. The front female mounting plate 13 has a plurality of through holes 131 thereon, and the rear female mounting plate 14 also has a plurality of through holes 141 thereon which are one-to-one corresponding to the plurality of through holes 131 on the front female mounting plate 13.

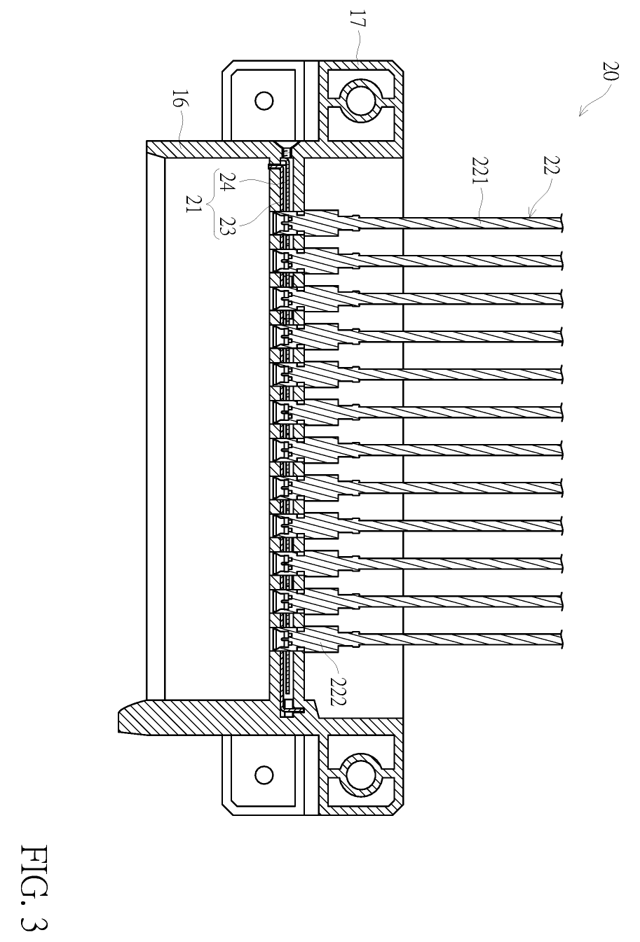

Please refer to FIGS. 2 and 3. The female cable module 20 includes a female engagement assembly 21 and a plurality of female cable terminals 22. The female engagement assembly 21 is for installing and clamping the plurality of female cable terminals 22 thereon, and the female engagement assembly 21 is shape-matched and detachably mounted in the female installation slot 102 of the female housing 10. In this embodiment, the female engagement assembly 21 comprises a female fixed engagement piece 23 and a female shifting engagement piece 24 combined with each other. The female fixed engagement piece 23 is formed with a plurality of fixed engagement holes 231 thereon, the female shifting engagement piece 24 is formed with a plurality of extended holes 241 thereon, and each fixed engagement hole 231 corresponds to a respective extended hole 241, and each fixed engagement hole 231 and the corresponding extended hole 241 are used to engage and fix the respective female cable terminal 22.

Please refer to FIG. 2. The female fixed engagement piece 23 has a fixed side-edge 232, a spring side-edge 233, an upper edge 235, and a lower edge 236. The upper edge 235 and the lower edge 236 are respectively provided with two hooked edges 237. The fixed side-edge 232 and the spring side-edge 233 each have a respective L-shaped bend in opposite directions. The spring side-edge 233 is also provided with two leaf springs 234 protruding toward the direction of the fixed side-edge 232. The female shifting engagement piece 24 has an upper edge 242, a lower edge 243, a shifting edge 244, and a forced edge 245. The shifting edge 244 has an L-shaped bend. When the female fixed engagement piece 23 and the female shifting engagement piece 24 are combined, the upper edge 242 and the lower edge 243 of the female shifting engagement piece 24 are respectively held between the hooked edges 237 respectively on the upper edge 235 and the lower edge 236 of the female fixed engagement piece 23. And the shifting edge 244 of the female shifting engagement piece 24 is located beyond the fixed side-edge 232 of the female fixed engagement piece 23, and the L-shaped bends of both the shifting edge 244 and the fixed side-edge 232 of the female fixed engagement piece 23 are in the same direction. Both ends of the female slot hole 15 each have a respective L-shaped bend in opposite directions. After the female fixed engagement piece 23 and the female shifting engagement piece 24 are combined to form the female engagement assembly 21, the female engagement assembly 21 can be installed in the female installation slot 102 through the female slot hole 15. The two ends of the female slot hole 15 each have a respective L-shaped bend in opposite directions, and the female slot hole 15 can accommodate the L-shaped bends of the fixed side-edge 232 and the spring side-edge 233 of the female fixed engagement piece 23 and the L-shaped bend of the shifting edge 244 of the female shifting engagement piece 24, so as to limit the degree of freedom of the female engagement assembly 21 in the female slot hole 15 and the female installation slot 102. At this time, the spring side-edge 233 of the female fixed engagement piece 23 is in close contact with the inner surface of the side portion with no screw hole of the female housing 10, and the forced edge 245 of the female shifting engagement piece 24 contacts the two leaf springs 234 of the spring side-edge 233 of the female fixed engagement piece 23 to bear elastic forces therefrom. The female shifting engagement piece 24 is acted upon by the elastic forces of the leaf springs 234, so that the shifting edge 244 of the female shifting engagement piece 24 is in contact with and against the inner surface of the side portion with a screw hole 18 of the female housing 10.

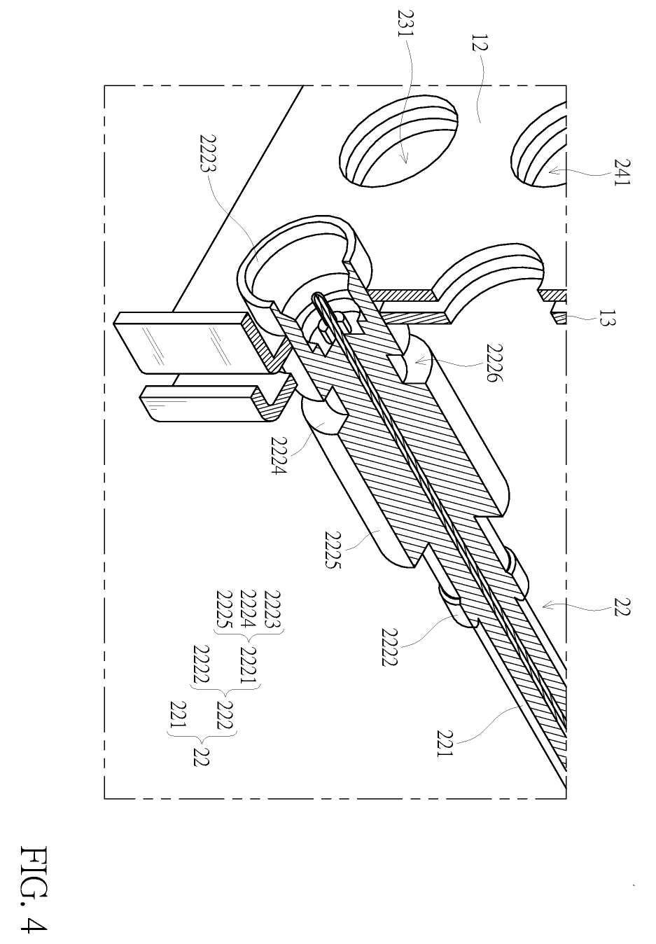

Please refer to FIG. 4. Each female cable terminal 22 comprises a female coaxial cable 221 and a female cable terminal head 222 respectively. The female cable terminal head 222 has a mating end 2221 and a wire end 2222. The mating end 2221 is a male or female end and has a front section 2223, a middle section 2224, and a rear section 2225. The front section 2223, the middle section 2224, and the rear section 2225 together form an engaging slot 2226 at the middle section 2224; the female coaxial cable 221 and the wire end 2222 of the female cable terminal head 222 are directly connected.

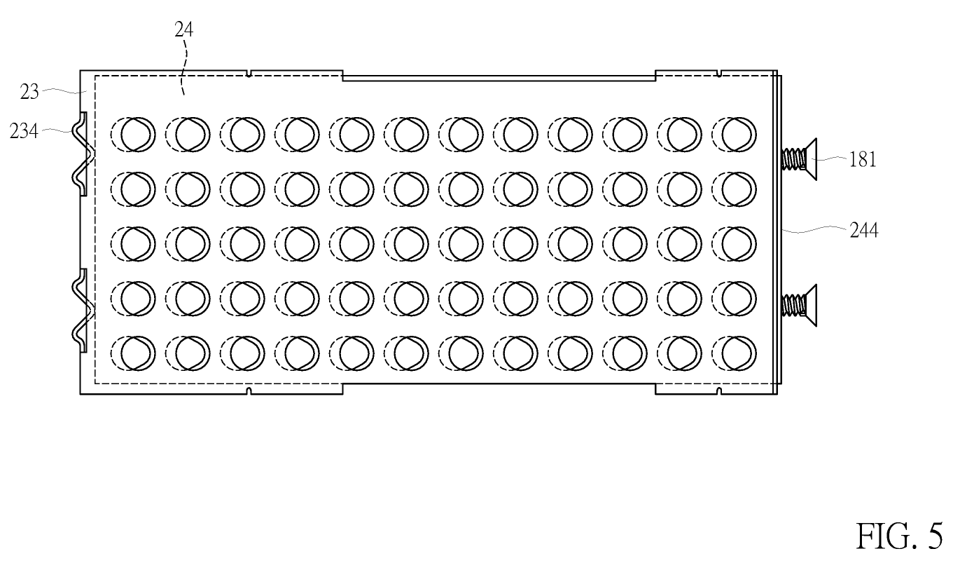

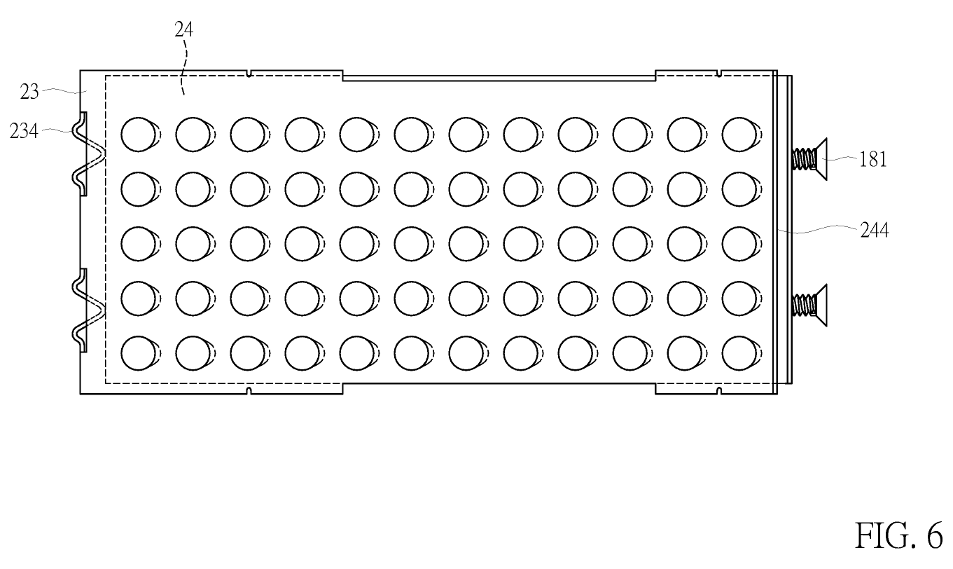

Please refer to FIG. 5 and FIG. 6. On the side of the female housing 10 with the screw hole 18, after being tightened through the screw hole 18, a screw 181 can directly contact and press on the shifting edge 244 of the engagement piece 24 to shift the female shifting engagement piece 24 so that the female shifting engagement piece 24 is in an inserting position. At this position, each fixed engagement hole 231 of the female fixed engagement piece 23, a first inner side of the respective extended hole 241 of the female shifting engagement piece 24, and a respective through hole 131 of the front female mounting plate 13 and a respective through hole 141 of the rear female mounting plate 14 are all aligned.

In this way, each female cable terminal head 222 can be passed through the respective through hole 141 of the rear female mounting plate 14, the first inner side of the corresponding extended hole 241 of the female shifting engagement piece 24, the corresponding fixed engagement hole 231 of the female fixed engagement piece 23, and the corresponding through hole 131 of the front female mounting plate 13. And the fixed engagement hole 231 and extended hole 241 of the female fixed engagement piece 23 and the female shifting engagement piece 24 are located in the engaging slot 2226 of the female cable terminal head 222.

When all the female cable terminal heads 222 are passed through the female fixed engagement piece 23 and the female shifting engagement piece 24, the screw 181 can be rotated out of the screw hole 18, so that the female shifting engagement piece 24 is pushed to an engaging position by the elastic force of the leaf spring 234; at this time, a second inner side of each extended hole 241 of the female shifting engagement piece 24 and the respective fixed engagement hole 231 together clamp and fix the respective engaging slot 2226 of the female cable terminal head 222, and thus the assembling of the female cable module 20 with the female housing 10 is completed to form the female connector F.

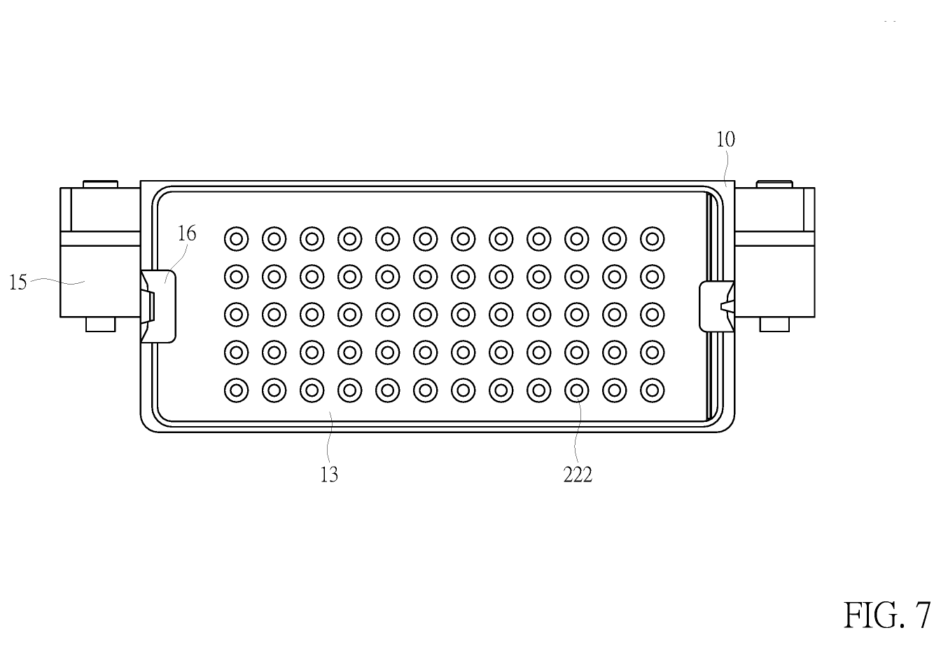

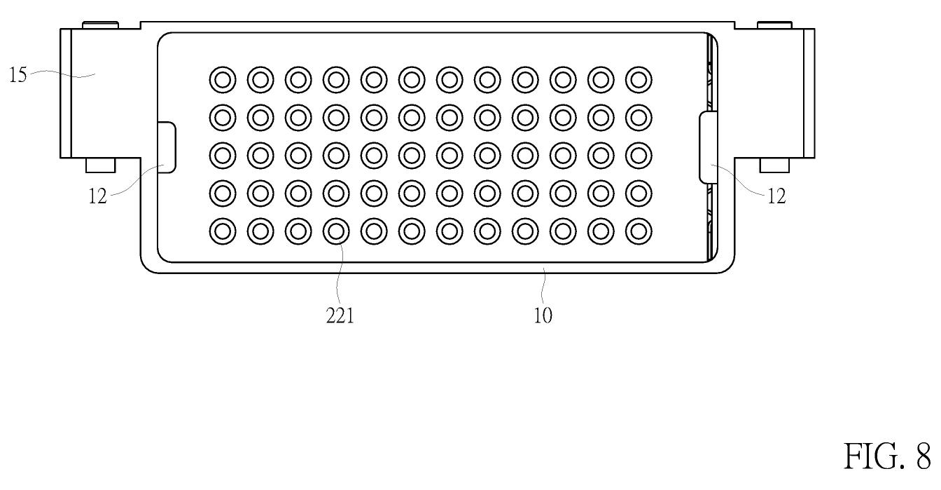

Please refer to FIG. 7: the female connector F faces a connection end of the male connector M. Please refer to FIG. 8: the female connector F faces away from a rear end of the male connector M.

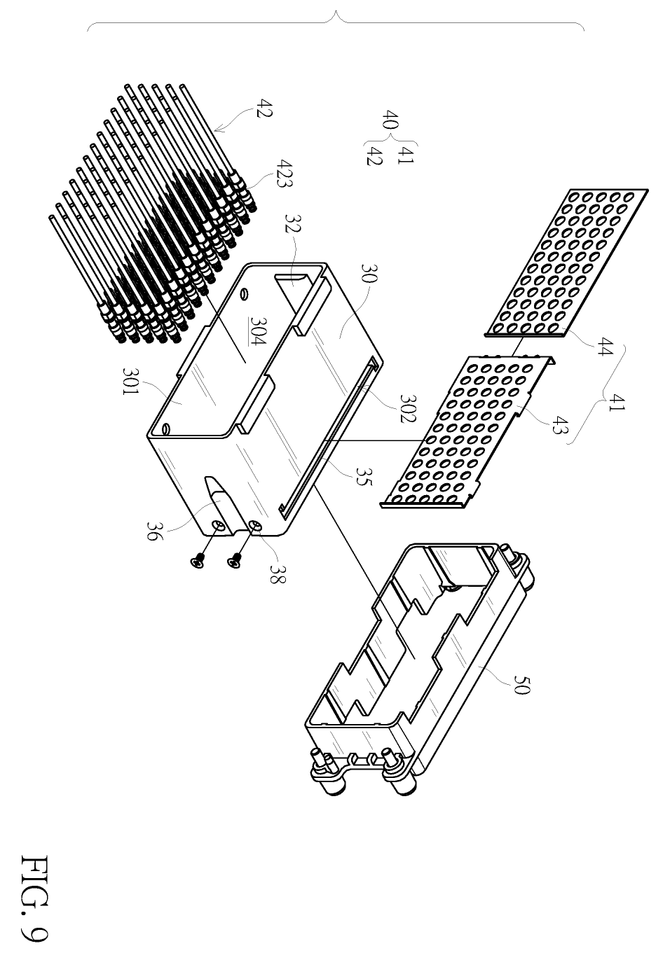

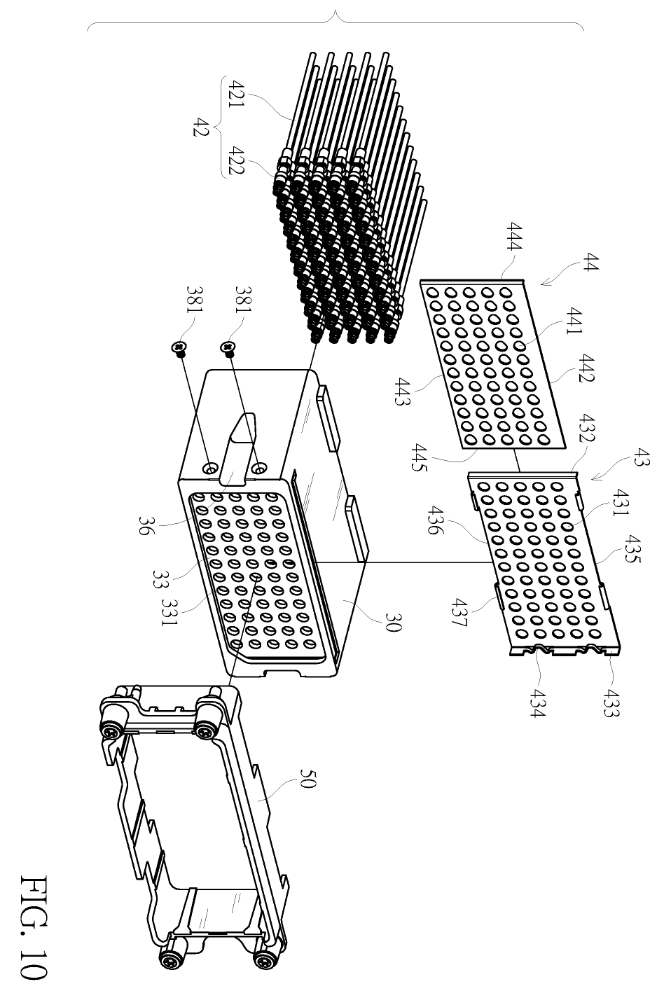

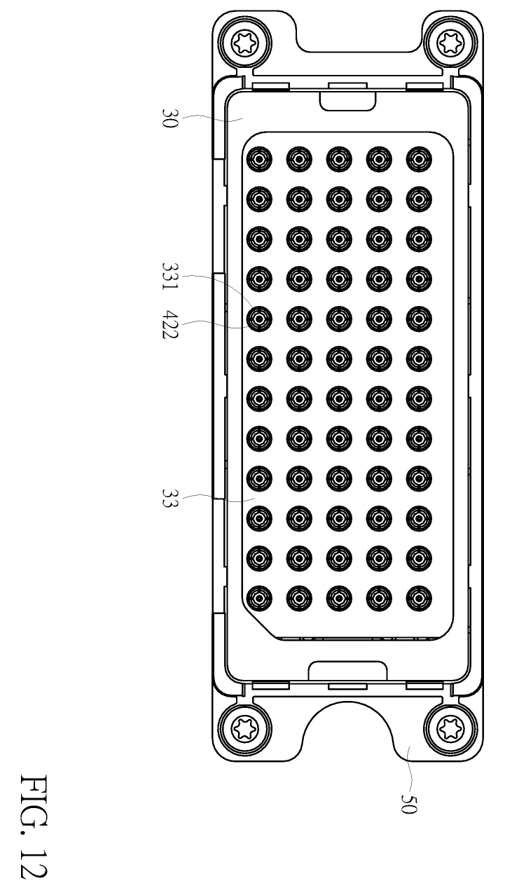

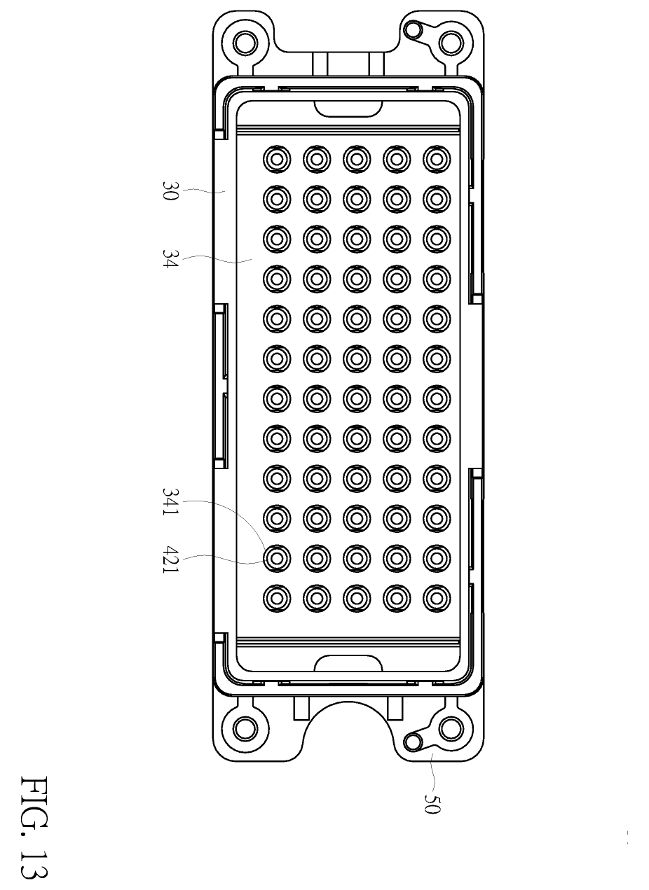

Regarding a specific preferred embodiment of the male connector M, please refer to FIG. 1, FIG. 9 and FIG. 10. The male connector M includes a male housing 30, a male cable module 40, and a locking casing 50; in this embodiment, the male housing 30 is mainly an end-to-end hollow rectangular frame comprising a top portion, a bottom portion and two side portions, and the hollow rectangular frame has an inner frame-surface 301, where inner surfaces of the top portion, the bottom portion and the two side portions are part of the inner frame-surface 301. The two side portions’ inner surfaces each have a respective elongated wedge 32 formed thereon. A front male mounting plate 33 and a rear male mounting plate 34 are provided inside the male housing 30 (with reference to FIG. 12 and FIG. 13). Both lateral sides of the front male mounting plate 33 and the rear male mounting plate 34 are respectively fixed with the wedges 32. A male slot hole 35 is formed on top of the male housing 30. And the front male mounting plate 33, the rear male mounting plate 34, and the male slot hole 35 together form a space of a male installation slot 302. The rear male mounting plate 34 and the inner frame-surface 301 form a space of a male cable slot 304. The male installation slot 302 and the male cable slot 304 are used to install the male cable module 40.

In this embodiment, in order to further facilitate the docking of the male connector M and the female connector F, the outer walls of both sides of the male housing 30 are respectively provided with a docking slot 36 to fit with the protrusion 16. The male housing 30 has engaging blocks on the top and bottom, and the locking casing 50 has complementary engaging slots at corresponding positions. Through the engaging blocks and engaging slots, the locking casing 50 can be engaged with the male housing 30. The casing 50 is further formed with four fixing holes on its outer surface, which can be used to fix the male housing 30 to a circuit board or other carrier through the fixing holes of the locking casing 50. Please refer to FIG. 12 and FIG. 13. The front male mounting plate 33 has a plurality of through holes 331 thereon. The rear male mounting plate 34 also has a plurality of through holes 341 thereon which are one-to-one corresponding to the plurality of through holes 331 on the front male mounting plate 33.

Please refer to FIGS. 9 and 10. The male cable module 40 includes a male engagement assembly 41 and a plurality of male cable terminals 42. The male engagement assembly 41 is for installing and clamping the plurality of male cable terminals 42 thereon, and the male engagement assembly 41 is shape-matched and detachably mounted in the male installation slot 302 of the male housing 30. In this embodiment, the male engagement assembly 41 comprises a male fixed engagement piece 43 and a male shifting engagement piece 44 combined with each other. The male fixed engagement piece 43 is formed with a plurality of fixed engagement holes 431 thereon, and the male shifting engagement piece 44 is formed with a plurality of extended engagement holes 441 thereon, and each fixed engagement hole 431 corresponds to a respective extended hole 441, and each fixed engagement hole 431 and the corresponding extended hole 441 are used to engage and fix each male cable terminal 42.

The male fixed engagement piece 43 has a fixed side-edge 432, a spring side-edge 433, an upper edge 435, and a lower edge 436. The upper edge 435 and the lower edge 436 are respectively provided with two hooked edges 437. The fixed side-edge 432 and the spring side-edge 433 each have a respective L-shaped bend in opposite directions, and the spring side-edge 433 is also provided with two leaf springs 434 protruding toward the direction of the fixed side-edge 432. The male shifting engagement piece 44 has an upper edge 442, a lower edge 443, a shifting edge 444, and a forced edge 445, and the shifting edge 444 has an L-shaped bend.

When the male fixed engagement piece 43 and the male shifting engagement piece 44 are combined, the upper edge 442 and the lower edge 443 of the male shifting engagement piece 44 are respectively held between the hooked edges 437 respectively on the upper edge 435 and the lower edge 436 of the male fixed engagement piece 43. And the shifting edge 444 of the male shifting engagement piece 44 is located beyond the fixed side-edge 432 of the male fixed engagement piece 43, and the L-shaped bends of the shifting edge 444 and the fixed side-edge 432 of the male fixed engagement piece 43 are in the same direction.

Both ends of the male slot hole 35 each have a respective L-shaped bend in opposite directions. After the male fixed engagement piece 43 and the male shifting engagement piece 44 are combined to form the male engagement assembly 41, the male engagement assembly 41 can be installed in the male installation slot 302 through the male slot hole 35. The two ends of the male slot hole 35 each have a respective L-shaped bend in opposite directions, and the male slot hole 35 can accommodate the L-shaped bends of the fixed side-edge 432 and the spring side-edge 433 of the male fixed engagement piece 43 and the L-shaped bend of the shifting edge 444 of the male shifting engagement piece 44 so as to limit the degree of freedom of the male engagement assembly 41 in the male slot hole 35 and the male installation slot 302.

At this time, the spring side-edge 433 of the male fixed engagement piece 43 is in close contact with the inner surface of the side portion with no screw hole of the male housing 30, and the forced edge 445 of the male shifting engagement piece 44 contacts the two leaf springs 434 on the side-edge 433 of the male fixed engagement piece 43 to bear elastic forces therefrom. The male shifting engagement piece 44 is acted upon by the elastic forces of the leaf springs 434, so that the shifting edge 444 of the male shifting engagement piece 44 is in contact with and against the inner surface of the side portion with a screw hole 38 of the male housing 30.

The male cable terminal 42 is similar in structure to the female cable terminal 22. Each male cable terminal 42 comprises a male coaxial cable 421 and a male cable terminal head 422 respectively. The male cable terminal head 422 has a mating end and a wire end, and the mating end is a female end or a male end, and complementarily corresponds to the mating end 2221 of the female cable terminal head 222. The mating end of the male cable terminal head 422 has a front section, a middle section, and a rear section. The front section, middle section, and rear section form an engaging slot at the middle section; the male coaxial cable 421 is connected to the wire end of the male cable terminal 422.

Similar to the arrangement in the female connector F in FIGS. 5 and 6, on the side of the male housing 30 with a screw hole 38, after being tightened through the screw hole 38, a screw 381 can directly contact and press on the shifting edge 444 of the male shifting engagement piece 44 to shift the male shifting engagement piece 44 so that the male shifting engagement piece 44 is in an inserting position. At this time, each fixed engagement hole 431 of the male fixed engagement piece 43, a first inner side of the respective extended hole 441 of the male shifting engagement piece 44 and a respective through hole of the front male mounting plate 33, and a respective through hole of the rear male mounting plate 34 are all aligned.

In this way, each male cable terminal head 422 can be passed through the corresponding through hole of the rear male mounting plate 34 respectively, the first inner side of the corresponding extended hole 441 of the male shifting engagement piece 44, the corresponding fixed engagement hole 431 of the male fixed engagement piece 43, and the corresponding through hole of the front male mounting plate 33. And the fixed engagement hole 431 and extended hole 441 of the male fixed engagement piece 43 and the male shifting engagement piece 44 are located in the engaging slot of the male cable terminal head 422.

When all the male cable terminal heads 422 are passed through the male fixed engagement piece 43 and the male shifting engagement piece 44, the screw 381 can be rotated out of the screw hole 38, so that the male shifting engagement piece 44 is pushed to an engaging position by the elastic forces of the leaf springs 434, at this time, a second inner side of each extended hole 441 of the male shifting engagement piece 44 and the respective fixed engagement hole 431 together clamp and fix the respective engaging slot of the male cable terminal head 422, and thus the assembling of the male cable module 40 with the male housing 30 is completed to form the male connector M.

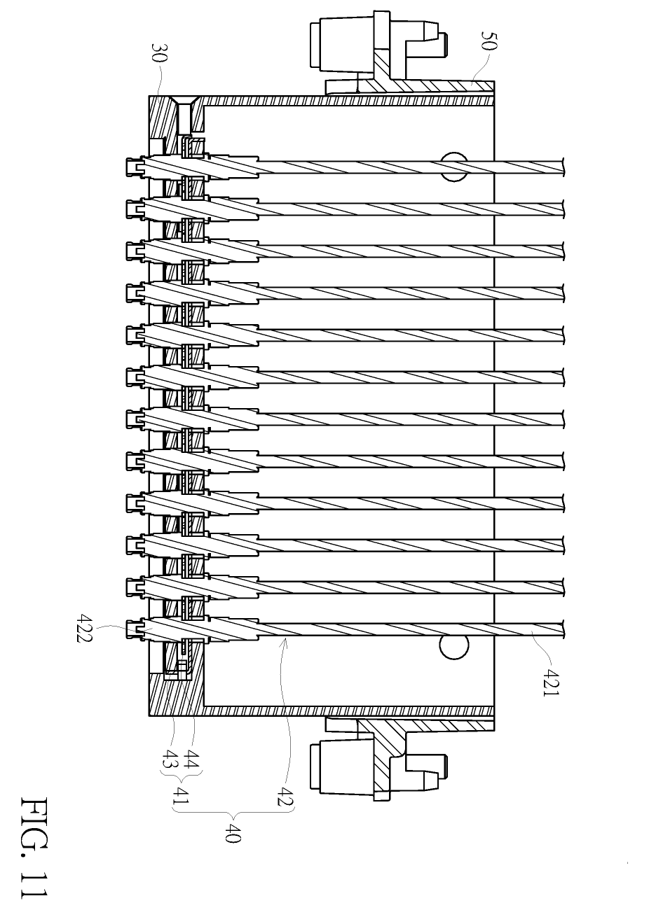

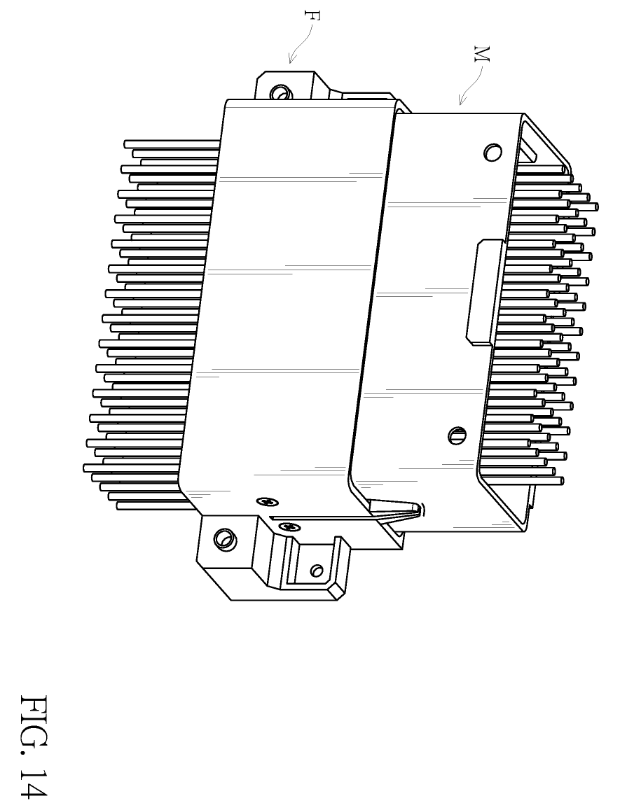

Please refer to FIG. 11, which shows a cross-sectional view of the male connector M. Please refer to FIG. 12, which shows a connection end of the male connector M facing towards the female connector F. Please refer to FIG. 13 together. FIG. 13 shows a rear end of the male connector M facing away from the female connector F. Please refer to FIG. 14, which shows the appearance of the male connector M and the female connector F after they are connected.

As can be seen from the above, the way of connecting a connector to a coaxial cable of the present invention is to directly connect the coaxial cable to a terminal head, and directly fixes the terminal head on the connector, and when the coaxial cable is to be connected to another coaxial cable through another connector, the terminal heads on the two connectors are directly connected, thereby eliminating extra interface connection structure between the coaxial cable and the connector, so as to effectively reduce impedance and signal loss. The technical principles of the present invention are described above in connection with specific embodiments. These descriptions are only intended to explain the principles of the present invention, and are not to be construed in any way as a limitation on the scope of protection of the present invention. Based on the explanations herein, other specific embodiments of the present invention can be associated by those skilled in the art without creative labor, and these equivalent variations or substitutions are included in the scope limited by the claims of this application.

Although the present invention has been disclosed as above by way of a preferred embodiment, it is not intended to limit the present invention, and any one skilled in the art may make certain changes and modifications without departing from the spirit and scope of the present invention, and therefore the scope of protection of the present invention shall be subject to the scope of the appended patent claims as defined herein.

What is claimed is:

1. An electrical connector with reduced signal loss, including a connector which comprises:
a housing, being hollow, having a front mounting plate and a rear mounting plate inside the housing, an installation slot formed between the front mounting plate and the rear mounting plate, and a plurality of through holes formed respectively on the front mounting plate and the rear mounting plate, and the through holes on the front mounting plate each respectively corresponding to the through holes on the rear mounting plate;
a cable module provided with a plurality of cable terminals detachably installed on a fixed engagement assembly; wherein
the fixed engagement assembly is shape-matched and detachably installed in the installation slot, and the fixed engagement assembly has a plurality of engagement holes; each cable terminal has a terminal head and a coaxial cable respectively, each terminal head has a mating end and a wire end respectively and the mating end is disposed in and through one of the plurality of engagement holes of the fixed engagement assembly, one of the plurality of through holes of the front mounting plate, and one of the plurality of through holes of the rear mounting plate; and the wire end is connected to the coaxial cable.

2. The electrical connector with reduced signal loss as claimed in claim 1, wherein
the fixed engagement assembly comprises a fixed engagement piece and a shifting engagement piece corresponding to each other, a plurality of fixed engagement holes is formed on the fixed engagement piece, a plurality of extended holes is formed on the shifting engagement piece, the fixed engagement holes each respectively correspond to the extended holes, and each engagement hole is formed by a respective one of the fixed engagement holes and a respective one of the extended holes; and
each terminal head of the cable terminals is disposed in and through a respective one of the engagement holes and passed through a respective one of the through holes on the front mounting plate, and the coaxial cable of each cable terminal passed through a respective one of the through holes on the rear mounting plate.

3. The electrical connector with reduced signal loss as claimed in claim 1, wherein more than one wedge is formed on an inner side of the housing, and the front mounting plate and the rear mounting plate are fixed with the more than one wedge.

4. The electrical connector with reduced signal loss as claimed in claim 1, wherein a male slot hole is provided on a top portion of the housing and between the front mounting plate and the rear mounting plate to connect the installation slot to outside of the housing; the cable module is installed in the installation slot through the male slot hole.

5. The electrical connector with reduced signal loss as claimed in claim 2, wherein the housing is provided with at least one screw hole, a screw is driven into the installation slot through the at least one screw hole and exerts thrust on the shifting engagement piece.

6. The electrical connector with reduced signal loss as claimed in claim 2, wherein the fixed engagement piece has a spring side-edge with at least one leaf spring thereon, and a forced edge of the shifting engagement piece is in contact with the at least one leaf spring to bear an elastic force therefrom.

7. The electrical connector with reduced signal loss as claimed in claim 6, wherein when a shifting edge of the shifting engagement piece is pushed to an inserting position, the terminal head of each cable terminal is passed through the respective engagement hole, where the shifting edge and the spring side-edge are opposite sides of the shifting engagement piece.

8. The electrical connector with reduced signal loss as claimed in claim 7, when the shifting edge of the shifting engagement piece is pushed to an engaging position, and the terminal head of each cable terminal is clamped and fixed in the respective engagement hole by the corresponding fixed engagement hole and the extended hole.

9. The electrical connector with reduced signal loss as claimed in claim 1, the connector being a female connector, which includes:
a female housing being an end-to-end hollow rectangular frame comprising a top portion, a bottom portion and two side portions, and with an inner frame-surface inside, and a mating slot formed by the inner frame-surface and the front mounting plate; and
inner walls of the two side portions of the female housing each forming a respective protrusion protruding beyond the mating slot, and one end of the protrusion gradually tapered.

10. The electrical connector with reduced signal loss as claimed in claim 2, the connector being a female connector, which includes:
a female housing being an end-to-end hollow rectangular frame comprising a top portion, a bottom portion and two side portions, and with an inner frame-surface inside, and a mating slot formed by the inner frame-surface and the front mounting plate; and
inner walls of the two side portions of the female housing each forming a respective protrusion protruding beyond the mating slot, and one end of the protrusion gradually tapered.

11. The electrical connector with reduced signal loss as claimed in claim 3, the connector being a female connector, which includes:
a female housing being an end-to-end hollow rectangular frame comprising a top portion, a bottom portion and two side portions, and with an inner frame-surface inside, and a mating slot formed by the inner frame-surface and the front mounting plate; and
inner walls of the two side portions of the female housing each forming a respective protrusion protruding beyond the mating slot, and one end of the protrusion gradually tapered.

12. The electrical connector with reduced signal loss as claimed in claim 4, the connector being a female connector, which includes:
a female housing being an end-to-end hollow rectangular frame comprising a top portion, a bottom portion and two side portions, and with an inner frame-surface inside, and a mating slot formed by the inner frame-surface and the front mounting plate; and
inner walls of the two side portions of the female housing each forming a respective protrusion protruding beyond the mating slot, and one end of the protrusion gradually tapered.

13. The electrical connector with reduced signal loss as claimed in claim 5, the connector being a female connector, which includes:
a female housing being an end-to-end hollow rectangular frame comprising a top portion, a bottom portion and two side portions, and with an inner frame-surface inside, and a mating slot formed by the inner frame-surface and the front mounting plate; and
inner walls of the two side portions of the female housing each forming a respective protrusion protruding beyond the mating slot, and one end of the protrusion gradually tapered.

14. The electrical connector with reduced signal loss as claimed in claim 6, the connector being a female connector, which includes:
a female housing being an end-to-end hollow rectangular frame comprising a top portion, a bottom portion and two side portions, and with an inner frame-surface inside, and a mating slot formed by the inner frame-surface and the front mounting plate; and
inner walls of the two side portions of the female housing each forming a respective protrusion protruding beyond the mating slot, and one end of the protrusion gradually tapered.

15. The electrical connector with reduced signal loss as claimed in claim 1, the connector being a male connector, and the male connector including:
a male housing being an end-to-end hollow rectangular frame comprising a top portion, a bottom portion and two side portions, and with an inner frame-surface inside, and a docking slot formed on an outer surface of the two side portions of the male housing.

16. The electrical connector with reduced signal loss as claimed in claim 2, the connector being a male connector, and the male connector including:
a male housing being an end-to-end hollow rectangular frame comprising a top portion, a bottom portion and two side portions, and with an inner frame-surface inside, and a docking slot formed on an outer surface of the two side portions of the male housing.

17. The electrical connector with reduced signal loss as claimed in claim 3, the connector being a male connector, and the male connector including:
a male housing being an end-to-end hollow rectangular frame comprising a top portion, a bottom portion and two side portions, and with an inner frame-surface inside, and a docking slot formed on an outer surface of the two side portions of the male housing.

18. The electrical connector with reduced signal loss as claimed in claim 4, the connector being a male connector, and the male connector including:
a male housing being an end-to-end hollow rectangular frame comprising a top portion, a bottom portion and two side portions, and with an inner frame-surface inside, and a docking slot formed on an outer surface of the two side portions of the male housing.

19. The electrical connector with reduced signal loss as claimed in claim 5, the connector being a male connector, and the male connector including:
a male housing being an end-to-end hollow rectangular frame comprising a top portion, a bottom portion and two side portions, and with an inner frame-surface inside, and a docking slot formed on an outer surface of the two side portions of the male housing.

20. The electrical connector with reduced signal loss as claimed in claim 6, the connector being a male connector, and the male connector including:
a male housing being an end-to-end hollow rectangular frame comprising a top portion, a bottom portion and two side portions, and with an inner frame-surface inside, and a docking slot formed on an outer surface of the two side portions of the male housing.
